(19) United States
(12) Patent Application Publication
(10) Pub. No.: US 2014/0226164 A1
(43) Pub. Date: Aug. 14, 2014

(54) LOW-DISPERSION STEP-PHASE INTERFEROMETER

(71) Applicant: Optoplex Corporation, Fremont, CA (US)

(72) Inventor: Yung-Chieh Hsieh, San Jose, CA (US)

(21) Appl. No.: 14/133,534

(22) Filed: Dec. 18, 2013

Related U.S. Application Data
(63) Continuation-in-part of application No. 14/088,385, filed on Nov. 23, 2013.
(60) Provisional application No. 61/738,952, filed on Dec. 18, 2012.
(60) Provisional application No. 61/730,467, filed on Nov. 27, 2012.

(51) Int. Cl. G01B 9/02

(52) U.S. Cl. CPC G01B 9/02015
USPC 356/477; 356/450

(57) ABSTRACT

Optical communication systems are sensitive to chromatic dispersion. An optical interleaver structure is provided that provides a significantly reduced dispersion, obtained by using at least one of a proper coating and a desired phase offset of each interfering cavity.

### CROSS-REFERENCE TO RELATED APPLICATIONS

This application claims the benefit of U.S. Provisional Patent Application No. 61/738,952 titled “Low-dispersion Step-phase Interferometer,” filed Dec. 18, 2012, incorporated herein by reference. This application is a continuation-in-part of U.S. patent application Ser. No. 14/088,385 titled “Super-Steep Step-Phase Interferometer” filed Nov. 23, 2013, incorporated herein by reference, which claims the benefit of U.S. Provisional Patent Application No. 61/730,467 titled “Super-Steep Step-Phase Interferometer,” filed Nov. 27, 2012, incorporated herein by reference.

### BACKGROUND OF THE INVENTION

1. Field of the Invention

The present invention relates to the design and use of step-phase interferometers as optical interleavers for optical communication, and more specifically, it relates to improvements that produce reduced amount of chromatic dispersion compared to the dispersion of conventional optical interleavers.

2. Description of Related Art

In dense wavelength division multiplexing (DWDM) optical communication, various frequencies (wavelengths) of laser light are coupled into the same optical fiber. The information capacity is directly proportional to the number of channels in the fiber. Since the total usable wavelength range is limited (about a few tens of nanometers), the smaller the channel spacing, the more channels can fit into the same optical fiber, therefore enabling more communication capacity.

The minimum possible channel spacing is limited by the capability of the multiplexer (MUX) and the de-multiplexer (de-MUX). Currently, the standard channel spacing is 100 GHz (0.8 nm). The manufacturing costs increase dramatically when the channel spacing is less than 100 GHz. A cost-effective method is desirable for interleaving channels thereby enabling the use of higher bandwidth filters with lower channel spacing in an optical communication system. For instance, one can use 100 GHz filters with 50 GHz channel spacing for using a one-stage interleave. Furthermore, if a two-stage interleave is implemented, 100 GHz filters can be used in 25 GHz channel spacing communication system.

The Michelson interferometer shows the fundamental requirement of interleaving. However, it is not practical to apply such an interferometer to a real interleave device since it is too sensitive to the central frequency and the line width of light source. If the frequency is slightly off from the integer, part of the optical power will leak from the bottom arm towards the left arm, causing cross talk between channels. In other words, in order to make this device work, the laser line width should be zero and its central frequencies have to be perfectly locked over all the operation condition. Such frequency locking is very hard to achieve in the real world.

U.S. Pat. No. 6,587,204 provides an interleave device using an optical interferometer where one of the beams carries a linear phase and the other beam carries a non-linear phase such that the frequency dependence of the phase difference between these two interference beams at the bottom arm has a step-like function with step π. Under this condition, the frequency dependence of phase difference between the two interference beams at the left arm also has the same step-like function but is offset by π, as a result of energy conservation. Thus, embodiments of a step-phase interferometer and the use of such interferometers as optical interleavers for optical communication are described in U.S. Pat. No. 6,587,204, incorporated herein by reference. The step-phase interferometer can be configured as a modified Michelson interferometer having reflectors in both the transmission and reflection arms. Because one of the reflectors is a Gires-Tournois etalon, instead of a simple mirror, this type of interferometer is sometimes herein referred to as a modified Michelson interferometer (MMI). Compared to an interleaver using birefringent technology, the MMI has a wider passband, but a greater chromatic dispersion. An MMI structure is desirable which produces a significantly reduced amount of chromatic dispersion compared to the dispersion of the prior art structures.

### SUMMARY OF THE INVENTION

A step-phase interferometer according to the teachings herein has an interferometer first arm including a linear phase offset spacer and a first resonant cavity, where the first resonant cavity is formed by a first partially reflective surface and a first mirror. An interferometer second arm has a second resonant cavity having a second partially reflective surface and a second mirror, where the first resonant cavity and the second resonant cavity are configured to have a relative phase offset of about 180 degrees at a desired operational wavelength range. A beamsplitter has a splitting location configured to split an input beam of light into a first beam and a second beam, where the beamsplitter is configured to direct the first beam into the first arm, where the first beam will propagate first through the linear phase offset spacer and will then be reflected by the first resonant cavity to produce a first reflected beam that will then return to the beamsplitter, where the beamsplitter is configured to direct the second beam into the second arm, where the second beam will be reflected by the second resonant cavity to produce a second reflected beam that will then return to the beamsplitter and combine with the first beam.

The optical path difference from the splitting location to the first partially reflective surface and the second partially reflective surface is about half the optical path length of the first resonant cavity and where the frequency dependence of the phase difference between the first reflected beam and the second reflected beam has a step-like function. The step of the phase difference is approximately Π.

A method utilizing the step-phase interferometer described above includes providing an input beam; and splitting the input beam at the splitting location to produce a first beam and a second beam, where the beamsplitter directs the first beam into the first arm, where the first beam propagates first through the linear phase offset spacer and is then reflected by the first resonant cavity to produce a first reflected beam which returns to the beamsplitter, where the beamsplitter directs the second beam into the second arm, where the second beam is reflected by the second resonant cavity to produce a second reflected beam that then returns to the beamsplitter and combines with the first reflected beam, where the optical path difference from the splitting location to the first partially reflective surface and the second partially reflective surface is about half the optical path length of the first resonant cavity and where the frequency dependence of the phase difference between the first reflected beam and the second reflected beam has a step-like function. The step of the phase difference is approximately Π.

In another embodiment, an optical step-phase interferometer includes a beamsplitter to separate an incident beam of light into a first beam of light and a second beam of light; a linear phase offset spacer operatively positioned within the path of the first beam of light; a first non-linear phase generator (NLPG) operatively positioned to reflect the first beam of light, after the first beam of light passes through the linear phase offset spacer, to produce a first reflected beam; and a second non-linear phase generator (NLPG) operatively positioned to reflect the second beam of light to produce a second reflected beam, where the first NLPG and the second NLPG are configured to have a relative phase offset of about 180 degrees at a desired operational wavelength range where the first reflected beam and the second reflected beam interfere with one another, where the frequency dependence of the phase difference between the first reflected beam and the second reflected beam has a step-like function. The step of the phase difference is approximately Π.

A method of interleaving frequencies of light is provided. The method includes separating, with a beamsplitter, an incident beam of light into a first beam of light and a second beam of light; passing the first beam of light through a linear phase offset spacer; reflecting the first beam of light with a first non-linear phase generator (NLPG), after the first beam of light passes through the linear phase offset spacer, to produce a first reflected beam; and reflecting the second beam of light with a second non-linear phase generator (NLPG) to produce a second reflected beam, where the first NLPG and the second NLPG are configured to have a relative phase offset of about 180 degrees at a desired operational wavelength range where the first reflected beam and the second reflected beam interfere with one another, where the frequency dependence of the phase difference between the first reflected beam and the second reflected beam has a step-like function.

### BRIEF DESCRIPTION OF THE DRAWINGS

The accompanying drawings, which are incorporated into and form a part of the disclosure, illustrate embodiments of the invention and, together with the description, serve to explain the principles of the invention.

FIG. 1 shows an optical cavity composed of two parallel optical surfaces, S1 and S2.

FIG. 2 shows a beam splitter 8, optical surface S3 and optical surface S4 and illustrates a synthetic cavity having an optical path length of L₃₄.

FIG. 3 shows a schematic diagram of a prior art step-phase interferometer.

FIG. 4 shows the optical path of an interferometer as a De-Mux.

FIG. 5A shows the phase difference Δφ and FIG. 5B shows the power spectrum of a prior art 50/100G MMI interleaver with coating PR-1=12%.

FIG. 6A shows the group delay and FIG. 6B shows the dispersion of a prior art 50/100G MMI interleaver with coating PR-1=12%, of which the power spectrum is shown in FIG. 5.

FIG. 7 shows a low-dispersion interleaver according to the present invention.

FIG. 8A shows the phase difference and FIG. 8B shows the power spectrum for an embodiment of the low-dispersion interleaver of FIG. 7, with PR-1=12% PR-2=0.5%.

FIG. 9A shows the group delay and FIG. 9B shows the dispersion for an embodiment of the low-dispersion interleaver of FIG. 7, with PR-1=12% PR-2=0.5%, whose power spectrum is shown in FIG. 8B

FIG. 10A shows the phase difference and FIG. 10B shows the power spectrum for an embodiment of the low-dispersion interleaver of FIG. 7, with PR-1=6%, PR-2=1%.

FIG. 11A shows the group-delay and FIG. 11B shows the dispersion (bottom) for an embodiment of the low-dispersion interleaver of FIG. 7, with PR-1=6%, PR-2=1%, whose power spectrum is shown in FIG. 10B.

### DETAILED DESCRIPTION OF THE INVENTION

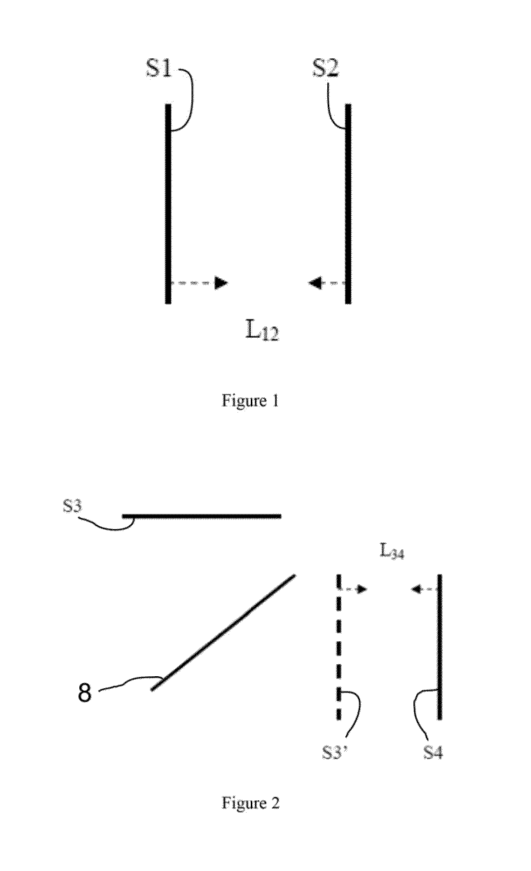

The present invention provides new MMI structures which produce a significantly reduced amount of chromatic dispersion compared to the dispersion of the prior art structures. FIG. 1 illustrates an optical cavity, which is composed of two parallel optical surfaces S1 and S2. In this example, each surface has a non-zero reflectivity, i.e., each surface has a degree of reflectivity. The free spectral range (FSR) of this cavity is defined as:

$$FSR = \frac{C}{2 {L}_{12}}$$

where C is the speed of light and L₁₂ is the optical path length of the cavity. Multiple reflections of the light beam in the cavity introduce chromatic dispersion to a reflected or transmitted beam of light.

FIG. 2 shows a beam splitter 8, optical surface S3 and optical surface S4. Both surface S3 and surface S4 have non-zero reflectivity. The optical path length of the upper arm is measured from the beamsplitter to surface S3. The dashed line referred to as S3′ is placed in the right arm at the same optical path length from the beamsplitter as that from the beamsplitter to surface S3. Thus, the optical path difference between the upper arm and the right arm is visually depicted as the optical path length L₃₄ between a synthetic cavity formed by surface S3′ and surface S4. The FSR of this synthetic cavity is defined as:

$$FSR = \frac{C}{2 {L}_{34}}$$

where L₃₄ is the optical path length of the cavity. When an incident beam enters the beam splitter from the left side, two output beams are produced; one is at the bottom of the beam splitter and the other is at the left of the beam splitter. Each of the output beams is formed by the interference of light reflected from surface S3 and that reflected from surface S4. The intensity of the output beam as a function of optical frequency is a sinusoidal, with a period that is equal to the FSR determined by L₃₄. The dispersion of the output beams is zero.

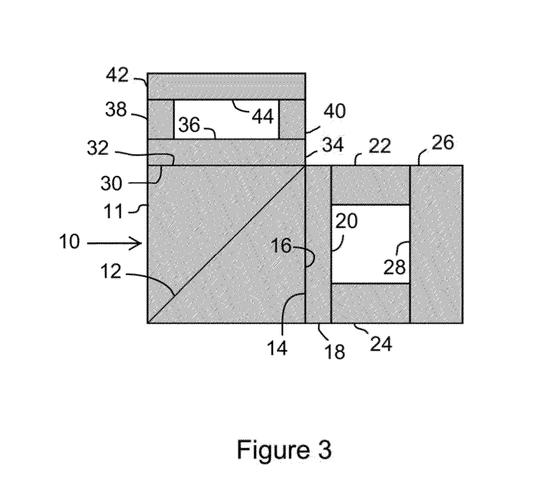

FIG. 3 shows an exemplary step-phase interferometer as taught in U.S. Pat. No. 6,587,204, which consists of a regular cavity and a synthetic cavity. Surface 20 is sometimes referred to herein as PR-1. Surface 28 is sometimes referred to herein as Mirror-1. PR-1 and Mirror-1 form a regular cavity, C-1. Surface 44 is sometimes referred to herein as Mirror-2. Mirror-2 and PR-1 constitute a synthetic cavity, C-2. For a 50G/100G interleaver, the FSR of C-1 is 50 GHz and that of C-2 is 100 GHz. The difference between the phase offset of C-1 and that of C-2 is either 0 or 180 degrees in the interested frequency region (e.g., C-band or L-band or a combination of these bands). In this configuration, only cavity C-1 contributes to the dispersion of the interleaver.

More specifically, the interferometer of FIG. 3 consists of a beam splitting cube 10 having an antireflection-coated input face 11 and a splitting interface 12. The right surface 14 is in optical contact, using optical contact bonding, with a first surface 16 of a transmissive optical element 18. Optical contact bonding is a glueless process whereby two closely conformal surfaces are joined together, being held purely by intermolecular forces. The second surface 20 of optical element 18 is configured such that it is partially reflective at a wavelength of interest. Second surface 20 is sometimes referred to herein as PR-1. Spacers 22 and 24 offset an element 26 from the first optical element 18. Surface 28 of element 26 is configured to be reflective at the wavelengths of interest. Surface 28 is sometimes referred to herein as Mirror-1. In this design, surface 20 and surface 28 form a first resonant cavity, referred to herein as C-1, having a cavity length L. The upper surface 30 of cube 10 is in optical contact with a first surface 32 of a transmissive optical element 34. The second surface 36 of optical element 34 is coated with an antireflection coating. Spacers 38 and 40 offset an element 42 from optical element 34. Surface 44 of element 42 is configured to be reflective at the wavelengths of interest. Surface 44 is sometimes referred to herein as Mirror-2. The optical path difference from the splitting interface 12 to surface 44 and from the splitting interface 12 to partially reflective surface 20 is L/2. For a 50G/100G interleaver, the free spectral range (FSR) of C-1 is 50 GHz.

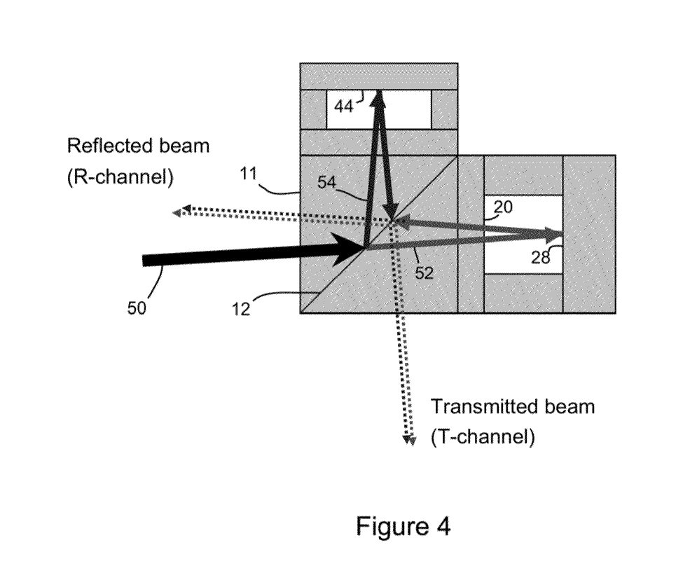

FIG. 4 shows the optical paths of the interferometer of FIG. 3 used as a DE-MUX. This device is a 2-beam interference interferometer. Both outputs, (the R-channel and the T-channel) are the results of two-beam interference. The intensity of the interference depends on the wavelength. To make an interleaver, the phase difference, Δφ, between the two interference beams have to be 0 (0 degree in phase) at the center of passband, and π (180-degree out of phase) at the center of stopband. For instance, in a 50G/100G interleaver, Δφ is a function of normalized frequency, having a step-function response with a step size of π for every 50G of frequency changes.

In FIG. 4, an incident beam 50 enters the interferometer through surface 11 from the left of cube 10. The beam splitter 12 separates the beam into two parts (52 and 54). Beam part 52 is transmitted through the beam splitter 12 and then hits surface 20 (PR-1) and surface 28 (Mirror-1). Beam part 54 is reflected from the beam splitter 12 and then hits surface 44 (Mirror-2). Both beam part 52 and beam part 54 are reflected back to hit beam splitter 12 again. After hitting the beam-splitter a second time, beam part 52 and beam part 54 interfere constructively or destructively, depending on the wavelength. As a result, the power spectrum on the left-hand side (in the R-channel) is different from that obtained at the bottom of the interferometer (in the T-channel).

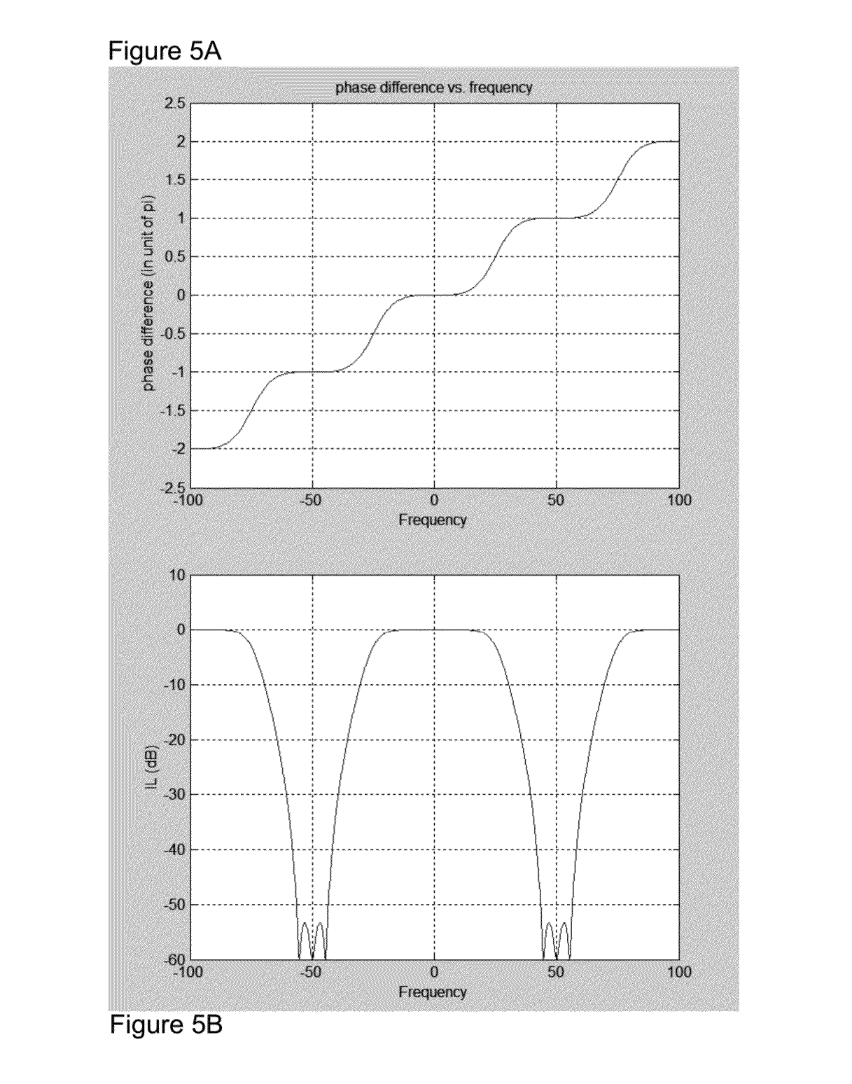

FIG. 5A shows the phase difference, Δφ, of the two interference beams of FIG. 4 at one of the two outputs and FIG. 5B shows the corresponding power spectrum. In this example, PR-1 is coated with 12% reflectivity. It should be noted that Δφ is a function of normalized frequency, and has a step-function response, which has a step size of π for every 50 GHz frequency changes (for a 50G/100G interleaver) as shown in FIG. 5A. For the sake of energy conservation, at the other output, the phase-difference as a function of frequency is the same as the top curve in FIG. 5A, but the vertical axis is offset by π. FIG. 5B shows that the optical intensity is near 100% (0 dB) at frequency near N×100 GHz, and is almost completely blocked at frequency near (N+0.5)×100 GHz, where N is an integer.

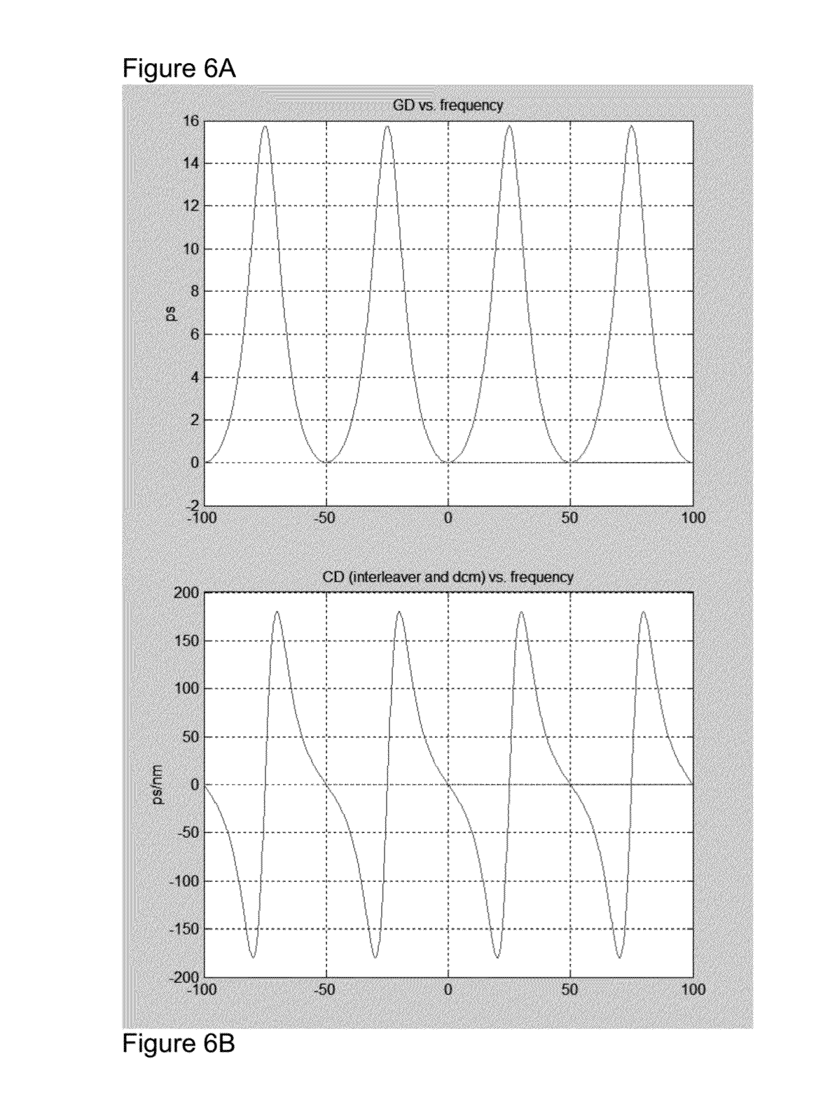

FIG. 6A shows the group delay and FIG. 6B shows chromatic dispersion (CD), in picoseconds/nm, of a standard MMI, with a 12% coating for PR-1. Within the passband (e.g., ITU+/−10 GHz), the dispersion is within +/−50 ps/nm. Notice that the dispersion is about zero at integer multiples of 50 GHz. Notice also the slope of the dispersion as it passes through zero.

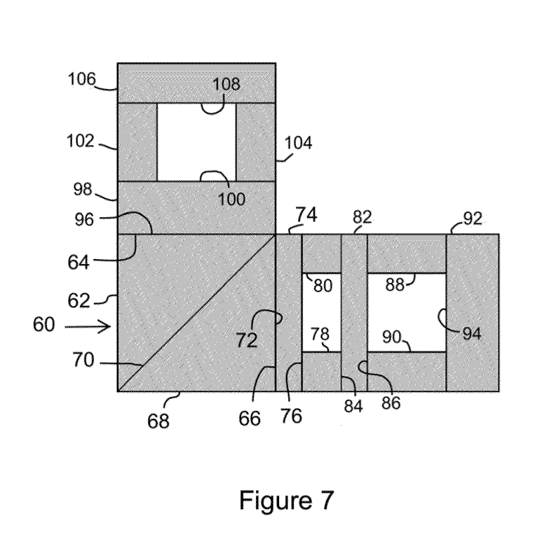

FIG. 7 shows an exemplary embodiment of a low-dispersion MMI interleaver according to the teachings of the present invention and comprises two regular cavities and one synthetic cavity. The example embodiment includes a beam splitting cube 60 with a face 62 which can include an AR coating, an upper face 64, a right face 66, a lower face 68 which can include an AR coating, and a beamsplitting interface 70. Surface 72 of optically transmissive element 74 is in optical contact (i.e., optical contact bonding) with right face 66 of cube 60. Surface 76 of element 74 is AR coated. Spacers 78 and 80 offset an element 82 from element 74. These spacers can be made of athermal material such as Zerodur, with CTE less than 0.3 ppm. As discussed below, spacers 78 and 80 function as a linear phase offset spacer element of the present interferometer. The material of element 82 is optically transparent and its surface 84 is AR coated. However, surface 86 of element 82 is partially reflective. Surface 86 is sometimes referred to herein as PR-1′. Note that in some embodiments, elements 74 and 82 are wedges which together cause surfaces 72 and 86 to be parallel and surfaces 76 and 84 to also be parallel. The purpose of the wedges is to eliminate or reduce ghost reflections. The wedges are formed by making surface 76 to be angled with respect to surface 72 and by making surface 84 to be angled with respect to surface 86. There is an air gap between surfaces 76 and 84. Spacers 88 and 90 offset an element 92 from element 82. These spacers can also be made of athermal material. Surface 94 of element 92 is configured as a mirror and is sometimes referred to herein as Mirror-1′. In this embodiment, there is an air gap between surfaces 86 and 94.

Surface 96 of element 98 is in optical contact, by optical contact bonding, with upper face 64 of beamsplitting cube 60. Surface 100 of element 98 is configured to be partially reflective at wavelengths of interest. Surface 100 is sometimes referred to herein as PR-2′. Note that in this embodiment, the combined thickness of elements 74 and 82 is about equal to the thickness of element 98. Thus, the path length difference of the beam splitter to PR-1′ and PR-2′ is mainly determined by the length of spacers 78 and 80. Together spacers 78 and 80 function as a linear phase offset spacer element of the interferometer. Spacers 102 and 104 offset an element 106 from element 98. These spacers are formed of athermal material. Element 106 includes a surface 108 configured as a mirror. Surface 108 is sometimes referred to herein as Mirror-2′. In this embodiment, there is an air gap between surfaces 100 and 108. U.S. Pat. No. 6,587,204 is incorporated herein by reference. Note that the common elements of U.S. Pat. No. 6,587,204 are aspects of and usable in embodiments of the present invention. Non-linear phase generators are described in the incorporated patent.

In this structure, surfaces PR-1′ and Mirror-1′ form a cavity C-1′ with a cavity length L. Similarly, surface PR-2′ and Mirror-2′ form cavity C-2′ also with a cavity length L. The relative cavity lengths of the two cavities are about equivalent (within a fraction of wavelength of the input light. The optical path difference from the beamsplitter to surface PR-1′ and from the beam splitter to PR-2′ is L/2. For a 50G/100G interleaver, the FSR of C-1′ and C-2′ is 50 GHz and the FSR of C-3′ is 100 GHz.

As shown in FIG. 7, surfaces PR-1′ and Mirror-1′ form a first regular cavity, C-1′; surfaces PR-2′ and Mirror-2′ form a second regular cavity, C-2′; surfaces PR-1′ and PR-2′ form a synthetic cavity, C-3′. For a 50G/100G interleaver, FSR of C-1 and C-2 is 50 GHz; and FSR of C-3 is 100 GHz. The difference between the phase offset of C-1 and that of C-3 is either 0 or 180 degrees. Since both C-1 and C-2 contribute to the dispersion, the difference of phase offset between C-1 and C-2 should be set to 180 degrees to minimize the net dispersion.

The phase offset, θₒ, of an optical cavity is defined as follows:

$$θ ( v ) = 2 π ( \frac{v}{FSR} ) + {θ}_{0}$$

where FSR is the free spectral range of the cavity, θ is the round-trip phase of the two parallel surfaces, θₒ is the cavity phase offset and ν is the frequency of the light. There are two ways to adjust the cavity phase offset. The first method is through adjusting the coating on the reflection surfaces. With the coating on the surface, the multiple reflection interference can alter the phase of the reflection beam. The second method is slightly adjusts the cavity length such that the small change in FSR does not affect the usage in the interested wavelength range. See the following example.

If there are two cavities, C1 and C2, that each have a FSR of 100 GHz and the same phase offset, θₒ, then

$${θ}_{1} ( v ) = {θ}_{2} ( v ) = 2 π ( \frac{v}{100} ) + {θ}_{0}$$

For both cavities, at 100 G ITU grids, the phase has offset θₒ. Now, if the cavity length is increased by about 0.3 μm (out of 1500 μm), the FSR of the second cavity is decreased by 0.02% (1/5000), we have

$$\begin{matrix}\begin{matrix}{θ}_{2} ( v ) = 2 π ( \frac{v}{100 ( 1 - \frac{1}{5000} )} ) + {θ}_{0} \\ \approx 2 π ( \frac{v}{100} ) ( 1 + \frac{1}{5000} ) + {θ}_{0} \\ = 2 π ( \frac{v}{100} ) + 2 π ( \frac{v}{100} ) ( \frac{1}{5000} ) + {θ}_{0} \\ = 2 π ( \frac{v}{100} ) + {θ}_{0}^{′}\end{matrix} & \\ {θ}_{0}^{′} = {θ}_{0} + 2 π ( \frac{v}{100} ) ( \frac{1}{5000} ) & \end{matrix}$$

For the optical frequency near 200 Thz (˜1.5 μm wavelength),

$${θ}_{0}^{′} = {θ}_{0} + 2 π ( \frac{v}{100} ) ( \frac{1}{5000} ) = {θ}_{0} + 0.8 π$$

In the above equation, the phase offset is altered by 0.8 π. Typically, to shift the cavity phase by 180 degrees, it requires altering the cavity length by about ¼ of the wavelength. The phase offset should be as close to 180 degrees as possible. Some applications will allow for a tolerance of up to 10%. The phase shift is directly proportional to the change of cavity wavelength.

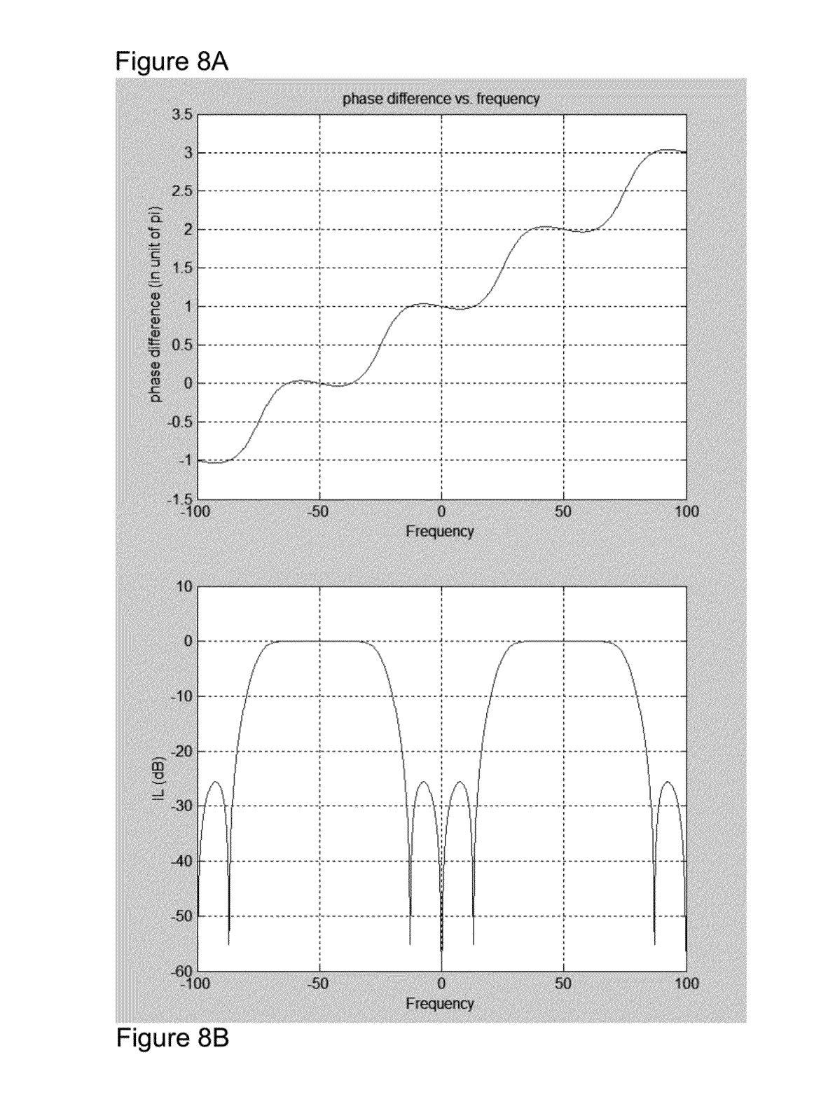

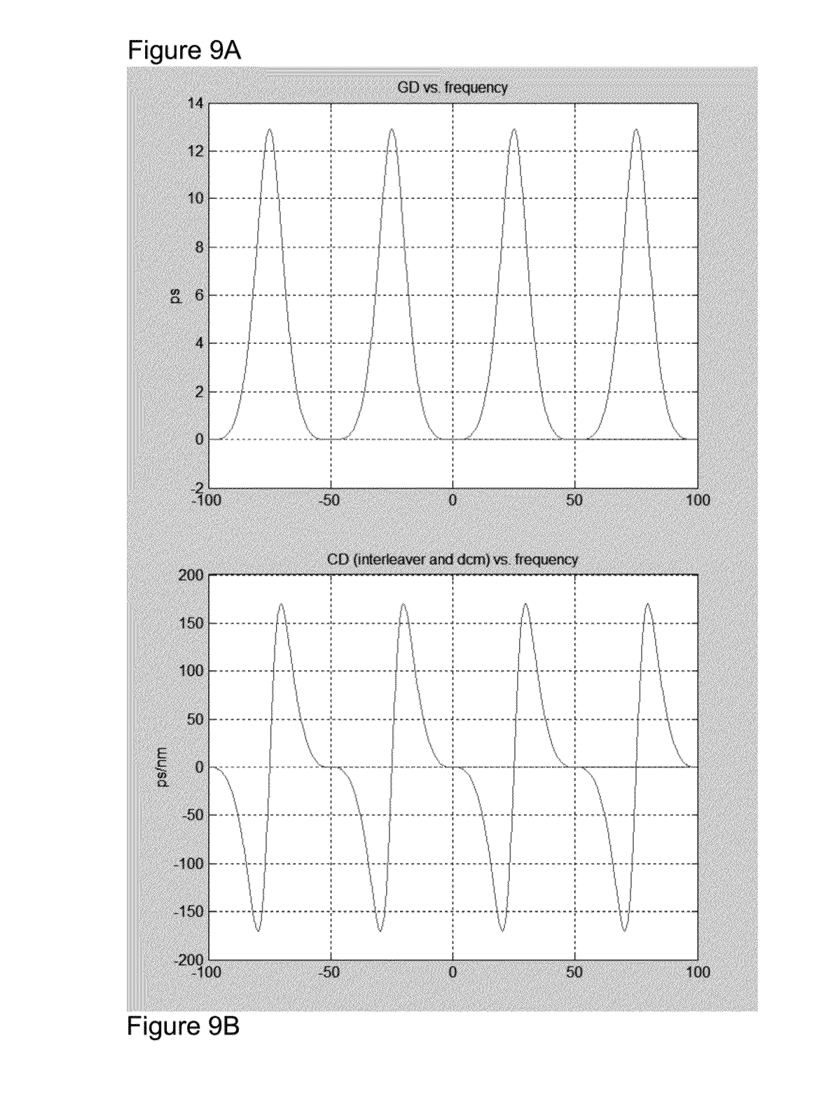

FIG. 8 shows Δφ and power spectrum at one of the outputs in a low-dispersion MMI. In this example, PR-1 is 12%; and PR-2 is 0.5%. FIG. 9A shows the corresponding group delay and FIG. 9B shows the dispersion. Notice the slope of the dispersion as it passes through zero at integer multiples of 50 GHz. Comparing the dispersion curve in FIG. 9B to that in FIG. 6B, the dispersion is less than 30 ps/nm within central +/−10G of passband. In FIG. 7, changing the reflectivity of PR-2, from 0.5% to 0% while maintaining PR-1=12%, the dispersion increases from less than 30 ps/nm to about 50 ps/nm, within the central +/−10 GHz bandwidth. As one can see, the function of the structure in FIG. 7 is identical to FIG. 3, if PR-2=0%. In summary, the coating on PR-2 has a significant effect on the dispersion.

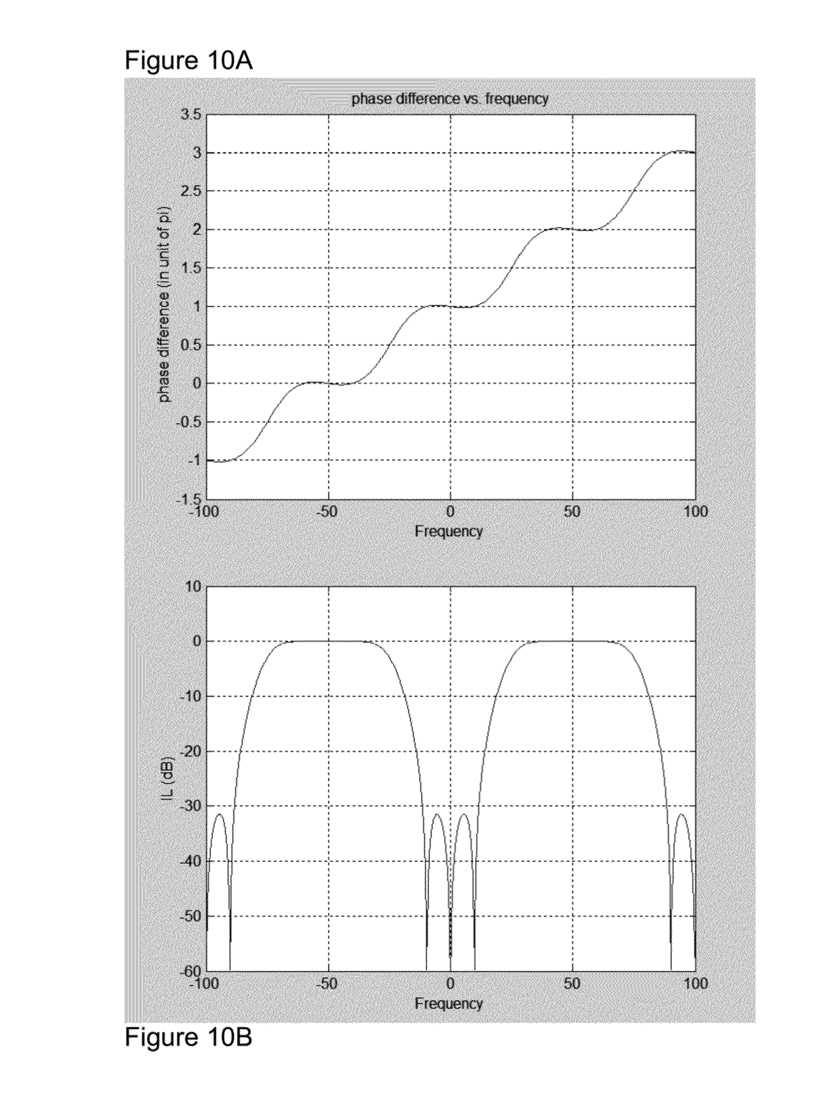

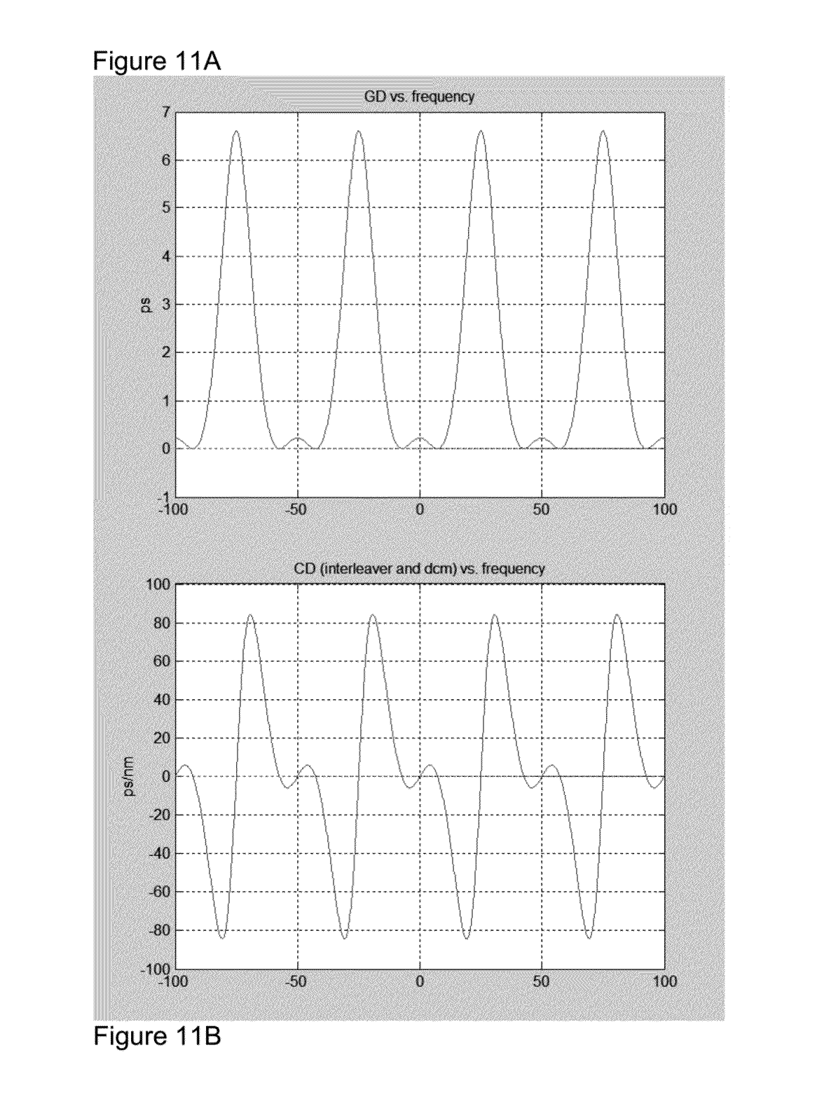

The following is another example of a low-dispersion interleaver in FIG. 7. In this example, PR-1 is 6% and PR-2 is 1%. FIG. 10A shows the phase difference, Δφ, and FIG. 10B shows the power spectrum at one of the outputs. FIG. 11A shows the corresponding group delay and FIG. 11B shows the dispersion. Within the central +/−10 GHz bandwidth, the dispersion is further reduced to less than 15 ps/nm.

The foregoing description of the invention has been presented for purposes of illustration and description and is not intended to be exhaustive or to limit the invention to the precise form disclosed. Many modifications and variations are possible in light of the above teaching. The embodiments disclosed were meant only to explain the principles of the invention and its practical application to thereby enable others skilled in the art to best use the invention in various embodiments and with various modifications suited to the particular use contemplated. The scope of the invention is to be defined by the following claims.

We claim:

1. A step-phase interferometer, comprising:
an interferometer first arm comprising a linear phase offset spacer and a first resonant cavity, wherein said first resonant cavity is formed by a first partially reflective surface and a first mirror;
an interferometer second arm comprising a second resonant cavity having a second partially reflective surface and a second mirror, wherein said first resonant cavity and said second resonant cavity are configured to have a relative phase offset of about 180 degrees at a desired operational wavelength range; and
a beamsplitter having a splitting location configured to split an input beam of light into a first beam and a second beam, wherein said beamsplitter is configured to direct said first beam into said first arm, wherein said first beam will propagate first through said linear phase offset spacer and will then be reflected by said first resonant cavity to produce a first reflected beam that will then return to said beamsplitter, wherein said beamsplitter is configured to direct said second beam into said second arm, wherein said second beam will be reflected by said second resonant cavity to produce a second reflected beam that will then return to said beamsplitter and combine with said first beam,
wherein the optical path difference from said splitting location to said first partially reflective surface and said second partially reflective surface is about half the optical path length of one of said first resonant cavity or said second resonant cavity and wherein the frequency dependence of the phase difference between said first reflected beam and said second reflected beam has a step-like function.

2. The optical step-phase interferometer of claim 1, wherein the step of said phase difference is approximately Π.

3. The optical step-phase interferometer of claim 1, wherein the optical path length of said first resonant cavity and the optical path length of said second resonant cavity differ by about a fourth of a desired operational wavelength.

4. The step-phase interferometer of claim 1, wherein said beamsplitter comprises an unpolarized beamsplitter.

5. The step-phase interferometer of claim 4, wherein said unpolarized beamsplitter comprises a symmetrical internal beam-splitting coating.

6. A method, comprising:
providing a step-phase interferometer, comprising:
an interferometer first arm comprising a linear phase offset spacer and a first resonant cavity, wherein said first resonant cavity is formed by a first partially reflective surface and a first mirror;
an interferometer second arm comprising a second resonant cavity having a second partially reflective surface and a second mirror, wherein said first resonant cavity and said second resonant cavity are configured to have a relative phase offset of about 180 degrees at a desired operational wavelength range; and
a beamsplitter having a splitting location configured to split an input beam of light into a first beam and a second beam, wherein said beamsplitter is configured to direct said first beam into said first arm, wherein said first beam will propagate first through said linear phase offset spacer and will then be reflected by said first resonant cavity to produce a first reflected beam that will then return to said beamsplitter, wherein said beamsplitter is configured to direct said second beam into said second arm, wherein said second beam will be reflected by said second resonant cavity to produce a second reflected beam that will then return to said beamsplitter and combine with said first beam,
wherein the optical path difference from said splitting location to said first partially reflective surface and said second partially reflective surface is about half the optical path length of one of said first resonant cavity or said second resonant cavity and wherein the frequency dependence of the phase difference between said first reflected beam and said second reflected beam has a step-like function;
providing an input beam; and
splitting said input beam at said splitting location to produce a first beam and a second beam, wherein said beamsplitter directs said first beam into said first arm, wherein said first beam propagates first through said linear phase offset spacer and is then reflected by said first resonant cavity to produce a first reflected beam which returns to said beamsplitter, wherein said beamsplitter directs said second beam into said second arm, wherein said second beam is reflected by said second resonant cavity to produce a second reflected beam that then returns to said beamsplitter and combines with said first reflected beam,
wherein the optical path difference from said splitting location to said first partially reflective surface and said second partially reflective surface is about half the optical path length of said first resonant cavity and wherein the frequency dependence of the phase difference between said first reflected beam and said second reflected beam has a step-like function.

7. The method of claim 6, wherein the step of said phase difference is approximately Π.

8. The method of claim 6, wherein the optical path length of said first resonant cavity and the optical path length of said second resonant cavity differ by about a fourth of a desired operational wavelength.

9. The method of claim 6, wherein said beamsplitter comprises an unpolarized beamsplitter.

10. The method of claim 9, wherein said unpolarized beamsplitter comprises a symmetrical internal beam-splitting coating.

11. An optical step-phase interferometer, comprising:
a beamsplitter to separate an incident beam of light into a first beam of light and a second beam of light;
a linear phase offset spacer operatively positioned within the path of said first beam of light;
a first non-linear phase generator (NLPG) operatively positioned to reflect said first beam of light, after said first beam of light passes through said linear phase offset spacer, to produce a first reflected beam; and
a second non-linear phase generator (NLPG) operatively positioned to reflect said second beam of light to produce a second reflected beam,
wherein said first NLPG and said second NLPG are configured to have a relative phase offset of about 180 degrees at a desired operational wavelength range, and
wherein said first reflected beam and said second reflected beam interfere with one another, wherein the frequency dependence of the phase difference between said first reflected beam and said second reflected beam has a step-like function.

12. The optical step-phase interferometer of claim 11, wherein the step of said phase difference is approximately Π.

13. The optical step-phase interferometer of claim 11, wherein the optical path length of said first NLPG and the optical path length of said second NLPG differ by about a fourth of a desired operational wavelength.

14. The optical step-phase interferometer of claim 11, wherein at least one of said first NLPG and said second NLPG comprises a plurality of partially reflecting surfaces and a reflective surface comprising nearly 100% reflectivity.

15. The optical step-phase interferometer of claim 11, wherein said first reflected beam and said second reflected beam are combined into two interference beams at said beam splitter, wherein a first interference beam of said two interference beams carries a first subset of signals and a second interference beam of said two interference beams carries a second subset of signals, wherein said first subset of signals is directed to a first port and said second subset of signals is directed to a second port.

16. The optical step-phase interferometer of claim 11, wherein said first NLPG comprises a first reflective surface and a second reflective surface that are separated, wherein said second NLPG comprises a third reflective surface and a fourth reflective surface that are separated.

17. The optical step-phase interferometer of claim 1, further comprising a second beamsplitter positioned to combine said first reflected beam and said second reflected beam to interfere with each other, wherein said optical step-phase interferometer is configured as an optical interleaving Mach-Zehnder type step-phase interferometer.

18. The optical step-phase interferometer of claim 11, further comprising an input fiber optic to provide said incident beam.

19. The optical step-phase interferometer of claim 15, further comprising a first output fiber optic and a second output fiber optic, wherein said first output fiber optic is positioned at said first port to collect said first subset and wherein said second fiber optic is positioned at said second port to collect said second subset.

20. The optical step-phase interferometer of claim 11, further comprising at least one fiber optic positioned to collect a beam comprising the interference of said first reflected beam and second reflected beam.

21. The optical step-phase interferometer of claim 15, further comprising a circulator to redirect said first subset of optical signals into a first port.

22. A method of interleaving frequencies of light, comprising:
separating, with a beamsplitter, an incident beam of light into a first beam of light and a second beam of light;
passing said first beam of light through a linear phase offset spacer;
reflecting said first beam of light with a first non-linear phase generator (NLPG), after said first beam of light passes through said linear phase offset spacer, to produce a first reflected beam;
reflecting said second beam of light with a second non-linear phase generator (NLPG) to produce a second reflected beam, wherein said first NLPG and said second NLPG are configured to have a relative phase offset of about 180 degrees at a desired operational wavelength range, and
wherein said first reflected beam and said second reflected beam interfere with one another, wherein the frequency dependence of the phase difference between said first reflected beam and said second reflected beam has a step-like function.
